(19) United States
(12) Patent Application Publication
(10) Pub. No.: US 2016/0201928 A1
(43) Pub. Date: Jul. 14, 2016

(54) NANOSTRUCTURE CHEMICAL MECHANICAL POLISHING INDUCED LIVE NANO-STRUCTURES FOR LIME-SCALE PREVENTION ON HEATING ELEMENTS

(71) Applicants: Gul Bahar BASIM, Istanbul (TR); OZYEGIN UNIVERSITESI, Istanbul (TR)

(72) Inventor: Gul Bahar BASIM, Istanbul (TR)

(73) Assignee: OZYEGIN UNIVERSITESI, Istanbul (TR)

(21) Appl. No.: 14/913,317

(22) PCT Filed: Dec. 31, 2013
(86) PCT No.: PCT/TR2013/000378

§ 371 Date: Feb. 19, 2016

(30) Foreign Application Priority Data
Aug. 21, 2013 (TR) 2013/09981

(51) Int. Cl. F24D 19/00; H05B 3/18; H05B 3/82

(52) U.S. Cl. CPC F24D 19/0092; H05B 3/82; H05B 3/18; Y10S 977/932; B82Y 30/00

(57) ABSTRACT

The present invention relates to the heating elements (1) used in heating of liquid materials. The present invention particularly relates to a heating element (1) operating in contact with a liquid and comprising a nanostructure (30) capable of continuously preventing limescale (20) build up in the heating zone (10) by means of the self-cleaning method.

### TECHNICAL FIELD

The present invention relates to the heating elements used inside a liquid (particularly water) for the purpose of heating the liquid. The present invention predominantly focuses on a heating element operating in contact with a liquid and comprising of Chemical Mechanical Polishing induced nanostructures which are capable of constantly preventing limescale build-up at the liquid/heating element interface.

### PRIOR ART

The heating elements used to heat liquids generally operate in direct contact with the liquid environment which is typically water with ionic contents such as calcium and magnesium. The electrochemical reactions in between the materials like aluminum or stainless steel that the heating elements are made of and the impurities of water lead to formation of limescale on the heating elements. The resulting limescale prevents the heat exchange from the heating element through the liquid by significantly thickening over the time (reaching to millimeter to centimeters) and significantly reduces the operating efficiency. In the case where the limescale continues to build up, heating element cannot fulfill the heating function and also loses electrical functionality due to deterioration of the materials surface.

Resistors are used as the heating elements in various liquid heating products such as washing machines, dishwashers, kettles, water heaters, boilers or machinery and boilers of industrial production. In the applications listed above, resistors are generally in contact with the liquid to enable heat exchange. Thus, hard water containing a high concentration of ions tend to form limescale layers on the resistors. Micro-nanoscale surface roughness on the resistors create point of nucleation for scale formation. Surface roughness of the conventional heating elements have an uncontrolled and irregular surface micro/nano structure (it may be locally too rough or smooth or it may comprise of variable micro-nanoscale roughness-smoothness). The uncontrolled surface nature of the heating element lead to typically observed uneven limescale growth on the resistor surface. To control the surface roughness and smoothen the surface of heating element, the common approach is to apply coatings on the resistors. However, application of a coating made of another material on the heater surfaces will result in multiple problems including; (i) a new uncontrolled surface roughness of the coated material will be exposed, (ii) an additional interface between the material the heating element is made of and the coating material will be created inducing extra layer of unbalanced stresses and (iii) the additional coating material results in inefficiency in heat transfer. Therefore, coating the surfaces of the heating elements is not a vey optimal or functional solution to prevent the limescale problems.

Limescale, in addition to the deposition due to the nucleation promoting roughness on the surfaces, can also result from the electrochemical reaction taking place between the metal surface of the resistor and water soluble ions. Hence it can be said that the scale formation process is driven by both mechanical and chemical factors. The electrochemical reactions taking place on the heating element depend on the electrochemical nature of the material/coating as well as the degree of surface roughness.

Resistors are made of metallic materials such as aluminum or stainless steel and for some cases they are subjected to the nickel diffusion or coated with various materials such as gold, aluminum, ceramics and teflon in order to prevent or reduce limescale formation. The optical micrographs of the heating elements coated with these alternative materials illustrate variable surface topography and surface roughness values.

The gold coating being the most effective among the mentioned coatings helps reduce limescale build up; however, it does not completely prevent limescale formation. Over time, rusting and deterioration takes place on the base material due to peeling of the overly grown limescale layers exposing the base metal. As the limescale layers fall from the surface, corrosion takes place due to damage of both the coating and main steel material. In addition, utilization of gold coating significantly increases the unit price of the heating elements and hence cannot be used for commercial applications.

In the current state of the art, heating elements are coated using coating materials building up less limescale in order to reduce limescale formation. However, these coatings also cause the heating element to transmit less heat. Over time, an unavoidable limescale formation on the applied coating layer is still observed.

In the current state of the art, cleaning of the limescale build up is practiced by applying vibration to the system by means of a vibration device for improvement. However, the use of an additional device leads to an increase in the cost and additionally wears the connections of the heater unit at the contact points where it is connected to the appliance over time.

Presently, anti limescale chemicals are also used in systems to prevent and reduce the formation of limescale. However, most of the available anti limescale chemicals are not preferred as they lead to additional cost, inefficiency in preventing limescale scale formation in addition to the chemicals resulting in environmental pollution or simply due to the fact that the heated water is directly used for domestic purposes and cannot contain any chemicals.

In summary, an improvement in the relevant art is necessary due to the aforementioned drawbacks and the insufficiency of the existing solutions in the field.

### BRIEF DESCRIPTION OF THE INVENTION

The invention presented is developed based on inspiration from the existing drawbacks on the limescale prevention and seeks to address the problems mentioned in the previous section.

The primary objective of the present invention is to obtain a heating element capable of continuously and actively preventing limescale build up.

The present invention aims to prevent limescale build up on the heating element without inversely affecting the operating efficiency.

One of the objectives of the present invention is to reduce limescale formation without the need of an additional coating material but through directly providing micro/nanoscale smoothness/roughness on the base material used for the heating element.

Furthermore, the present invention is intended to form more regular nucleation points activating the limescale formation on the heating elements operating in a liquid environment by means of live nanostructures patterned on the heating element's surface and to activate the formed nanostructures through change in the environmental temperatures during the operation of the heating element so as to eliminate the limescale formation during the standard operation of the heating element.

Another objective of the present invention is to achieve a less expensive heating element capable of continuously cleaning the limescale building up on its surface thereon by applying interfacial stresses at the heater surface/limescale interface to induce stresses on the formed limescale layer by means of the nanostructures based on the difference in the thermal expansion coefficient of the two materials.

The present invention, in order to achieve the aforementioned objectives, relates to a heating element operating in contact with a liquid, wherein it comprises of surface nanostructures enabling the removal of the limescale formed on the heating zone through creating an interfacial stress at the heating element surface and limescale interface and hence resulting in cracking of the uniformly formed limescale structure.

In order to achieve the aforementioned objectives, roughness values (rms) of the nanostructures are designed between 20 nm and 20 μm range. In addition, the mentioned nanostructures are formed by means of the CMP process.

The structural and the characteristic features and all advantages of the present invention will be detailed more clearly with the following section through figures and their descriptions. Therefore, the invention should be evaluated by taking the given figures and their detailed descriptions into consideration.

### FIGURES FOR UNDERSTANDING THE PRESENT INVENTION

FIG. 1: A picture of the plausible heating element that can be used with the present invention.

FIG. 2a: A schematic representation of the surface of the heating element without nanostructure induced on the surface.

FIG. 2b: A schematic representation of the surface of the heating element with nanostructure.

FIG. 2c: A schematic representation illustrating the limescale build up on the surface of the heating element with nanostructure.

FIG. 2d: A schematic representation illustrating interfacial stress formation at the metal/limescale interface resulting from expansion/contraction of the heating element with a nanostructure and the formed limescale due to the difference in their thermal expansion coefficients.

FIG. 2e: A schematic representation illustrating live nano-structure's self-cleaning ability by means of cracking the limescale layer due to the stresses formed at the interface.

The drawings are not to the scale but are illustrations to demonstrate the present invention. Furthermore, the parts that are identical or are less substantial are indicated with the same number.

### DESCRIPTION OF PART REFERENCES

1. Heating element
5. Heating element surface
10. Heating zone
20. Limescale
30. Nanostructure
35. Interface
40. Crack

### DETAILED DESCRIPTION OF THE INVENTION

In this detailed description, heating element (1) according to the present invention and preferred embodiments thereof are described only for a better understanding of the subject without constituting any restrictions.

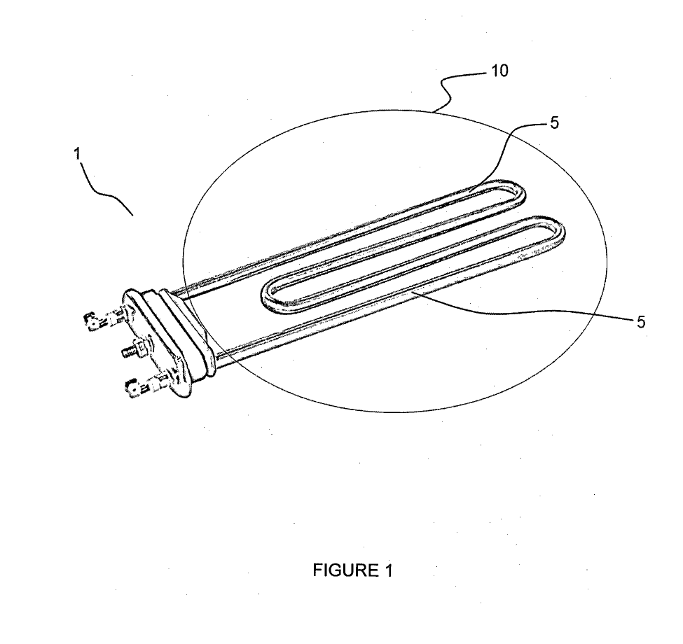

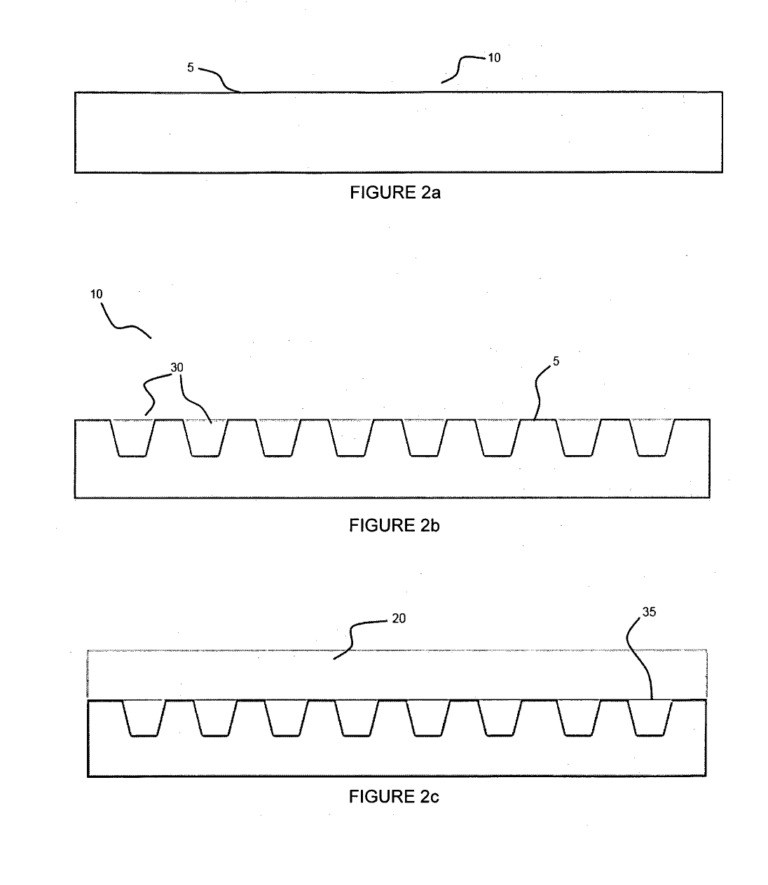

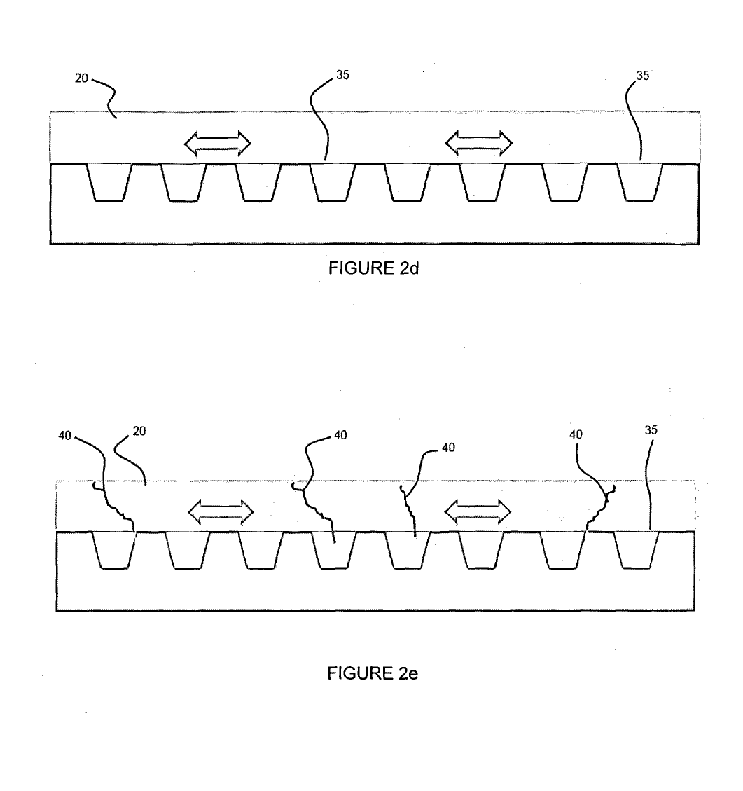

The present invention comprises of a heating element (1) with surface nanostructure (30) primarily increasing limescale (20) build up on the heating zone (10) with regularly induced nucleation points and then actively cleaning the formed limescale (20) by creating a stress at the interface (35) due to difference in the thermal expansion coefficients of the base material that the heating element is made and the limescale layer itself. In FIG. 1, a view of the heating element (1) suitable to the present invention is illustrated. As shown in the figure, heating element (1) is a resistor operating in contact with a liquid in various appliances such as washing machines, dishwashers, kettles, industrial machinery and boilers where liquids are heated. In FIGS. 2a-b, a schematic representation of the surface of the heating element (1) without and with a nanostructure (30) is illustrated.

Through nanostructureing, random nanostructures (30) on the heating zone (10) of the resistor with CMP technique (1), nanostructures (30) function based on the thermal expansion coefficient difference of the metal and limescale (20). In FIG. 2c, a schematic representation illustrating the limescale (20) build up on the surface (5) of the heating element (1) with a nanostructure (30) and nanostructures (30) causing the limescale (20) to crack and peel of the surface by high interfacial stresses induced as the temperature changes on the resistor (1) limescale (20) interface (35) by exhibiting a higher expansion/contraction than the accumulated limescale (20) during the standard operation of the resistor (1) (heating/cooling). In FIG. 2d, a schematic representational view illustrating stress formation at the interface (35) resulting from expansion/contraction of the heating element (1) with a nanostructure (30) and limescale (20) build up on the surface (5) thereof at different rates due to the thermal expansion coefficient difference between the materials. In FIG. 2e, a schematic representational view illustrating self-cleaning of the heating element (1) by means of cracking and falling of the limescale (20) due to the stress formation at the interface is given. As shown in FIG. 2e, cracks (40) form on the limescale (20) due to the formation of stress at the interface (35).

The stress forming on the limescale (20) during the heating/cooling cycle helps the accumulated limescale (20) layers to crack and separate from the heating element (1). Continuous removal of the limescale (20) accumulated in the heating zone (10) prevents deformation of the metal surface. Forming the nanostructures (30) on heating elements (1) without a coating and with a coating (aluminum, gold, teflon coating, etc.) is possible.

Nanostructures (30) are formed by means of Chemical and Mechanical Polishing (“CMP”) process. In this process,
a down force of 70 to 150 N is applied and
Suba IV or a polimeric subpad,
a polymeric based toppad which is compatible with the material to be polished (IC1000 or the like),
an abrasive paper (with an average particle size of 45 μm and 90 μm),
a water based chemical suspension comprising of nanoparticles made of alumina, silica, etc. formulated with oxidizer and stabilizer chemicals,
oxidizing agents, pH regulators etc' are used.

With the CMP process, nano/microscale smoothness or nano/microscale roughness (30) can be provided on the surface (5) of the heating element (1). In addition, the surface (5) can also form a self-protective oxide layer.

Limescale (20) build up on the heating element (1) is prevented without a need for a coating. Limescale (20) build up continue to increase and it can be spontaneously cleaned by means of the interfacial (35) stresses formed when mentioned limescale layer (20) is not overgrown. Nanostructures (30) are directly formed on the steel resistor (1) surface (5). Roughness values (rms) of the formed nanostructures (30) vary between 20 nanometers (nm) and 20 micrometers (μm).

Nanostructures (30), apart from the CMP process, can also be formed by means of the sol-gel process or lithography method. However, the CMP process is the most economical of all available methods. The basic principles of the CMP process are formation of a film undergone a chemical change on the surface and mechanical abrasion of this film. Thus, micro/nanoscale patterning is provided on the surface. This method starts with forming a chemically modified nanofilm on the layer to be patterned and this nanofilm is formed using chemicals such as oxidizers, pH regulators and surface active agents, by taking into consideration of the characteristics of the layer selected to be patterned. This cross section is patterned in micro/nanoscale by means of the CMP method.

In the semiconductor applications of the CMP, a natural oxide film capable of protecting the metal from corrosion should form on the metallic material to be polished. In this manner, a system referred to as global planarization, i.e. planarizing entire surface when planarization is carried out on the wafer, providing material abrasion in high areas while preventing corrosion on the trench structures where metal level is low can be established. These films form naturally and they have a self-limited growth capacity since formation thereof is realized by forming an oxide layer through diffusion into the metal atoms. Self-protecting oxide films are compatible with the requirements of epitaxial strain. Because the lattice constants are close to the lattice constant of the main material (metal provided with oxide film formation). In addition, growth of these films are self-limited since oxide formation stops before the critical thickness is exceeded, upon stopping the oxygen diffusion. These films are continuous, nonporous, adhesive, permanent and unreactive. Therefore, they can prevent corrosion and be effectively used as a coating layer. Another important characteristic of these films is that they form naturally when the metal is exposed to a medium made of various chemical components.

The tendency of a metal-oxide film to protect the metal from oxidizing further depends on the volume of oxide and metal. When the oxide film forms at the metal/oxide interface, the volume change due to the oxide formation can be explained by means of the Pilling-Bedworth (P-B) ratio (measured at a high temperature) represented by the following equation.

$$PB - Ratio = \frac{{A}_{0} {ρ}_{M}}{{A}_{M} {ρ}_{0}}$$

In this equation, Aₒ is the molecular or formula weight of the oxide and A_{M} is the atomic weight of the metal. ρ_{O} and ρ_{M} are density of oxide and metal, respectively. If the P-B ratio<1, i.e oxide volume is less than metal volume (or lattice constant of the oxide film a, is smaller than that of the metal), a tensile stress arises in the oxide film. As the thickness of the oxide layer increases, oxide film starts to crack in order to compensate for this stress and becomes porous. Thus, chemical reaction, i.e. oxidation continues and the film, loses its protectiveness or cannot limit its growth. On the other hand, if oxide volume is much greater than the volume of metal (the P-B ratio>1), compressive stress starts to emerge as the film grows. Oxide film tries to release the stress energy by breaking the bonds at the metal-oxide interface. Ideal protective oxide is obtained when the P-B ratio is between 1 and 2. In this case, the oxide formed on the metal surface remains intact. The growth thereof is limited by the diffusion rate of metal ions in the oxide film. When there is a metal undergoing oxidation, the P-B ratio serves as a means for estimating stresses generated inside the film structure and morphology of the oxide film.

In oxidation in air, the P-B ratios of aluminum (Al), copper (Cu) and tungsten (W) films are 1.28, 1.68 and 3.4, respectively. In other words, Al and Cu form protective oxides in air, while W oxide is not protective and peeling thereof is expected when the critical thickness is exceeded. However, liquid medium used in the chemical and mechanical planarization applications, formation a protective metal-oxide film on the W surface is observed to occur. Therefore, depending on the composition of the aqueous medium, variation of P-B ratios is also expected.

Thickness of the oxide film on the metal surface depends on the strength of metal-oxide bonds. During the formation of thin films, when they reach a critical thickness, a medium providing thermodynamic conditions that can cause the film to partially or completely relax due to the atomic dislocations at the interface where the film joins with the main material. Thus, the film cannot maintain its strength above this critical thickness. As the film grows, stresses generated in the structure of the metal-oxide film are compensated with the metal-oxide bond strength (σ_{bond}) determined by the following equation.

$${σ}_{bond} = {[ \frac{{E}_{film} ( {γ}_{O} + {γ}_{S} )}{d} ]}^{1 / 2} = [ \frac{{K}_{Ic}}{{d}^{1 / 2}} ]$$

In this equation, E_{film} indicates the modulus of elasticity of the film, γ_{O} and γ_{S} indicate the surface energies of the location provided with the film and substrate, K_{lc} indicates the fracture toughness of the film substrate interface and d indicates the film thickness. When protective oxide film forms, internal stresses resulting from oxide growth (σᵢₙₜₑᵣₙₐₗ) exceeds the strength of the metal-oxide bond. However, since the P-B ratio is between 1-2, oxide structure is under compression. In a system, external stresses (σₑₓₜₑᵣₙₐₗ) experienced by the film should be taken into account in order to measure the strength of the oxide film, wherein said balance is expressed as in the following equation.

σ_{bond}=σᵢₙₜₑᵣₙₐₗ+σₑₓₜₑᵣₙₐₗ

By this equation, when the sum of internal and external stresses exceeds the strength of the bond, oxide film can be removed by breaking the bonds at the metal-oxide interface. Thus, the maximum compression level that the film can withstand or stabilization capacity thereof can be determined by measuring the stress at the interface and comparing the result with the σ_{bond}. Presented equations, in principle, apply to all nanofilms and coatings.

The nanostructures (30) according to the present invention are formed by adjusting the stress rates as described above so as to create an interface (35) stress being controlled with respect to the material forming the resistor (1) and enabling the limescale (20) to fall from the resistor (1) surface (5) by cracking.

In the current resistors (1), surface (5) roughness is uncontrolled and irregular. Controlled nano/micro roughness being formed is processed onto the smoothened surface thanks to the present invention. Thus, balanced and regular distribution of the stress forces enabling the limescale (20) to fall from the resistor (1) surface (5) is provided. Formed nano/micropatterns (30) are provided with a self-cleaning feature by forming a stress enabling the limescale (20) to fall even when there is a small amount of build up by reducing the critical stress amount (leading to the falling) since they increase the total surface area where stress will be generated.

In the current resistors (1), limescale (20) build up is on the order of centimeters (cm). Thanks to the present invention, cracking is provided when the limescale (20) build up is on the order of micrometers (μm) or millimeters (mm) and thus it falls from the surface (5).

Nanostructures (30) are formed by the abrasion of metal oxide protective film on the order of nanometers (nm) formed naturally during the CMP process by the nanometer sized particles being also present inside the CMP suspensions. The nanostructures (30) generate a high stress at the interface (35) by exhibiting an expansion/contraction much greater than that of the limescale (20) structure building up thereon. Provision of nano or microscale nanostructures (30) is possible.

1-3. (canceled)

4. A heating element operating in contact with a liquid, the heating element comprising:
a base material having a surface and a different thermal expansion coefficient than limescale;
controlled nanostructures on the base material surface; and
a nano-scale oxide film on the controlled nanostructures,
wherein the controlled nanostructures with the nano-scale oxide film enable limescale formed on the heating zone to crack and peel off due to interfacial stress on the base material surface and limescale interface.

5. The heating element according to claim 4, wherein roughness values (rms) of the nanostructures are between 20 nm and 20 μm.

6. The heating element according to claim 4, wherein said nanostructures are formed by means of a CMP process and provided with roughness control.

7. The heating element according to claim 4, wherein the base material has a thermal expansion coefficient higher than that of limescale.

8. The heating element according to claim 4, wherein the base material is a resistor made of metal.

9. A self-cleaning heating element operating in contact with a liquid, the heating element comprising:
a base material having nanostructures with a nano-scale oxide film forming a controlled micro- or nano-scale roughness,
wherein the base material has a different thermal expansion coefficient than limescale, such that stress is induced at the interface between the heating element with the nanostructures and a limescale formed thereon during the operation of the heating element, and
wherein the controlled micro- or nano-scale roughness is configured such that a regular distribution of stress forces is provided enabling a limescale formed on a heating zone of the heating element to crack and separate from the surface of the heating element.

10. The self-cleaning heating element according to claim 9, wherein the regular distribution of the stress forces is based on the nanostructures providing regularly spaced nucleation points for the formation of limescale and for the creation of stress.

11. The self-cleaning heating element according to claim 9, wherein the base material has a thermal expansion coefficient higher than that of limescale.

12. The self-cleaning heating element according to claim 9, wherein the base material is a resistor made of steel.

13. The self-cleaning heating element according to claim 9, wherein the roughness values (rms) of the nanostructures are between 20 nm and 20 μm.

14. A method for self-cleaning of a heating element, the method comprising:
providing a heating element comprised of a base material having a different thermal expansion coefficient than limescale;
forming nanostructures with a nano-scale oxide film on a surface of the base material to have a controlled micro- or nano-scale roughness; and
providing a regular distribution of stress forces enabling a limescale foil led on a heating zone of the heating element to crack and separate from the surface of the base material.

15. The method according to claim 14, wherein the regular distribution of stress forces is based on the nanostructures providing regularly spaced nucleation points for the formation of limescale and for the creation of stress.

16. The method according to claim 14, wherein the base material has a thermal expansion coefficient higher than that of limescale.

17. The method according to claim 14, wherein the base material is a resistor made of metal, in particular steel.

18. The method according to claim 14, wherein the roughness values (rms) of the nanostructures are between 20 nm and 20 μm.

19. The method according to claim 14, wherein the nanostructures are formed by means of a CMP process providing roughness control.
